(19) United States
(12) Patent Application Publication
(10) Pub. No.: US 2002/0070474 A1
(43) Pub. Date: Jun. 13, 2002

(54) Method for manufacturing a part out of amber as well as a part made of amber

(76) Inventors: Thomas Schloesser, Erbach (DE); Uwe Skrzypek, Moensheim (DE); Kay Lorenz, Hannover (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/011,167

(22) Filed: Dec. 6, 2001

(30) Foreign Application Priority Data
Dec. 8, 2000 (DE) 100 61 206.7

(51) Int. Cl. B29C 43/02; B29C 43/20; B29C 43/52

(52) U.S. Cl. 264/129; 264/259; 264/320; 264/322

(57) ABSTRACT

In vehicle manufacturing and many other technical application areas, new technical demands, on the one hand, and customer desires for change, on the other hand, require a constant search for new materials. The present invention provides for amber to be used in vehicle parts, and for a method in which a semifinished product is first manufactured out of amber and then the semifinished product is reshaped into a three-dimensional form.

Priority to German Patent Application No. 100 61 206.7, which is hereby incorporated by reference herein, is claimed.

### BACKGROUND INFORMATION

The present invention relates to a method for manufacturing a part out of amber as well as a part made of amber.

Amber has been used for centuries as jewelry. At a time when glass could not yet be manufactured in pure enough form, eyeglasses and magnifying glasses were ground out of amber. The plastic shaping was carried out exclusively by cutting out of the solid block. Due to the limited extent of natural deposits, already in 1879 a method for manufacturing pressed amber was developed, in which small natural amber pieces are placed into a heated pressure chamber, from which air has been removed, and then under high-pressure are pressed through a sieve, individual strands arising, that are joined to each other. This makes it possible, without adding a binding agent, to manufacture comparatively large-surface plates and rods, which are then further processed through cutting. This method is described for example in Jens Rehländer, Volker Handloik, “Amber” in GEO Special Ostsee, June 1998, AT Privilegium 1879/003726 from 1879 and in Japanese Patent Document No. 40 109 13. However, this method is cost-intensive and is suitable only for producing small quantities of exclusive jewelry and decorative objects, but not for manufacturing large quantities of everyday objects.

In addition to its purely decorative use in the jewelry industry, in the German Democratic Republic, amber was also used in the form of electrical insulators for radio and television devices, as described in the Rehländer article.

In vehicle manufacturing and many other technical application areas, new technical demands, on the one hand, and customer desires for change, on the other hand, require a constant search for new materials.

### SUMMARY OF THE INVENTION

An object of the present invention includes providing inexpensive parts, specifically vehicle parts, made of a material that has good technical and decorative properties. An additional or alternative object of the present invention is to provide for an economical method for manufacturing such parts.

The present invention provides a method for manufacturing a part out of amber, a semifinished product first being produced out of amber, wherein the semifinished product is reshaped into a three-dimensional form.

The present invention also provides a part made of amber, manufactured in accordance with the above methods. The part preferably is a component part of a vehicle.

The material according to the present invention thus is amber, which has not heretofore been used in vehicle manufacturing. For other application areas, parts made of amber have thus far only been manufactured by cutting from the solid block of natural or pressed amber. However, this method is not economical for large quantities.

The method according to the present invention provides an economical solution for the cost-effective production of parts made of amber, in which a preferably plate-shaped semifinished product of amber is manufactured and is then reshaped into a desired three-dimensional form. In this context, the original structure of the amber remains preserved, in particular, the phase boundaries. In addition, no additions of binding agents or other chemical additives are necessary, so that one may speak, in a promotionally advantageous manner, of a part, in particular, a vehicle part, that is made of a completely natural material.

The cost-effective method according to the present invention for the first time makes it economically feasible and therefore possible to use amber material in mass production, and it thus permits the exploitation of positive characteristics, which, in the previous application areas of the jewelry industry, have had no or very minor importance.

For example, with the present invention it is possible and economically feasible to use amber as a material for everyday objects, in particular for vehicle parts:

Housings and protective screens made of amber can be provided as an electrical insulator, while, at the same time, as a particular advantage, assuring electromagnetic compatibility (EMV).

Casings can be manufactured from amber, having dimensional stability and being polishable. It is possible to produce smooth and shiny solid surfaces that do not have a coat of varnish.

Dashboard panels made of amber are chemically resistant to conventional cleaning agents. The surface is not porous, i.e., it does not absorb other media and is therefore easy to clean.

Keys, knobs, and other operating devices made of amber possess good physiological properties; they are anti-bacterial and anti-allergenic.

Illumination means made of amber, in particular, headlight housings, produce a “warm,” comfortable, and non-disturbing or non-distracting light, because amber has moderate transparency and is weakly translucent.

Functional objects made of amber are also decorative.

Reshaping according to the present invention is known as any manufacturing process resulting in the plastic modification of the shape of a solid body while essentially maintaining the mass and material composition, as is described, by way of example, in DIN 8582 through 8587. Reshaping methods of this type are significantly more economical in manufacturing large quantities than the known cutting methods.

In this context, it is especially advantageous to mention pressing, in particular hot pressing. However, for manufacturing more massive components such as switches or knobs, a compression molding process using dip edge tools is advantageous.

Also suitable is thermoforming, in which the amber is first softened by heating and then is reshaped using pressure, for example, air pressure. As a special method, so-called diaphragm forming should be mentioned here. In this context, a preferably plate-shaped semifinished product is placed between two elastic membranes, the so-called diaphragms, whose interstitial space is evacuated. The semifinished product is heated to the point of softening and then, together with the diaphragms, is placed into a reshaping tool. The latter is preferably made up of only one tool half, which has a temperature below the softening temperature of the material. Diaphragm and softened semifinished product are pressed by air pressure into the tool half, and the semifinished product cools under the pressure of the mold and under isostatic pressure. In this context, it is advantageous that semifinished products having the most varied thicknesses can be processed in one tool, but also that only one tool half is required.

In one advantageous embodiment of the method according to the present invention, an illumination means or device, preferably a luminescent foil, is attached to the reshaped semifinished product, preferably on one side and over a large surface. The limited transparency of the amber furnishes a “warm” light, which, in its use in the motor vehicle area, illuminates but is not felt to be disturbing or distracting.

In one further advantageous embodiment of the method according to the present invention, the semifinished product, during the reshaping by a compression procedure, is applied, preferably laminated, to a carrier foil, for example, made of wood, paper, metal, or plastic. The coating increases the stability and thus permits the manufacture of very large-surface or large-volume parts so as to have longer-lasting stability at minimal use of the valuable material, amber.

In a further advantageous embodiment of the method according to the present invention, the reshaped semifinished product is varnished at least partially. In this way, the stability of the more stressed areas of the part's surface is increased.

The objective with respect to the part to be created is achieved according to the present invention as a result of the fact that it or at least one component is manufactured in accordance with one of the preceding methods.

The known methods only make possible the economical manufacture, in large quantities, of plates, rods, or other bodies having simple geometry. Parts having more complex geometries must be cut, in a cost-intensive manner, from the solid block. However, a part manufactured in accordance with the method according to the present invention is economical precisely in the manufacture of large quantities, and therefore makes possible the use of a material, amber, heretofore not used, which has good technical as well as decorative characteristics. In particular, waste and scraps of the jewelry industry, as well as very small or poorly formed natural products can be processed into pressed amber semifinished product and subsequently in accordance with the invention reshaped into everyday objects.

The vehicle part to be created thus has at least one component made of amber. As defined herein “at least one component” can include that the entire vehicle part is made of amber.

The material amber has thus far not at all been used in the vehicle area. Nevertheless, it possesses the aforementioned great number of suitable technical and decorative properties, which make this use sensible.

For this purpose, in accordance with known methods, small parts in small quantities can also be manufactured from solid blocks of natural or pressed amber using cutting methods.

Larger parts or their components, in particular having more complex geometries, can be manufactured economically according to the method of the present invention having the aforementioned advantages.

### BRIEF DESCRIPTION OF THE DRAWINGS

The present invention will be described with respect to the following drawings, in which:

FIG. 1 shows a semi-finished amber part being reshaped in a reshaping tool; and

FIG. 2 shows a vehicle part formed according to present invention.

### DETAILED DESCRIPTION

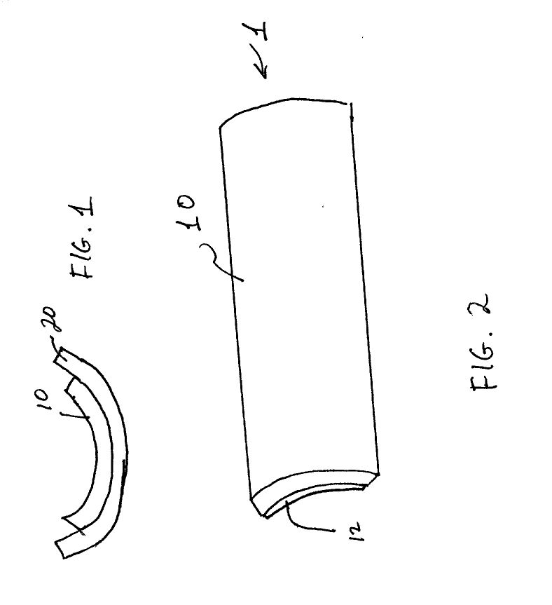

FIG. 1 shows a semi-finished plate-shaped amber part 10 being pressed into a reshaping tool 20 to provide a curved profile. “Plate-shaped” as defined herein includes sheet-like parts. The reshaping tool may be heated to aid in the reshaping.

FIG. 2 shows a vehicle part component 1, for example a part of a dashboard, made according to the method of the present invention. The reshaped amber part 10 can be used, for example, in a dashboard. A luminescent foil, carrier foil or varnish 12 can be applied to the part 10.

The method according to the present invention has proven to be particularly suitable for the economical manufacture of parts in accordance with the present invention having a more complex three-dimensional geometry. As examples from the vehicle area, dashboard panels or casing parts can be cited. In other application areas, it is well-suited, for example, for the manufacture of housings, for example, for telephones or monitors.

As vehicle parts according to the present invention, however, smaller components having simpler geometries can be cited, for example, knobs, switches, or applique, the insulating properties of the amber, for example, with regard to EMV, being here especially worthy of note as being advantageous.

The present invention is not limited only to the examples depicted above, but rather can be extended to other ones.

What is claimed is:

1. A method for manufacturing a part out of amber comprising the steps of:
first producing a semifinished product out of amber; and
reshaping the semifinished product into a three-dimensional form.

2. The method as recited claim 1, wherein the semifinished product is plate-shaped.

3. The method as recited in claim 1, wherein the semifinished product is reshaped by pressing.

4. The method as recited in claim 1, further comprising heating at least one of the semifinished product and a reshaping tool for the reshaping step before or during the reshaping step.

5. The method as recited in claim 1, further comprising attaching at least one illumination device is attached to the reshaped semifinished product.

6. The method as recited in claim 5, wherein the illumination device is a luminescent foil.

7. The method as recited in claim 1, wherein the reshaped semifinished product is attached to a carrier.

8. The method as recited in claim 6, wherein the reshaped semifinished product is laminated onto the carrier.

9. The method as recited in claim 7, wherein the carrier is a carrier foil.

10. The method as recited in claim 1, further comprising at least partially varnishing the reshaped semifinished product.

11. A part made of amber manufactured in accordance with the method of claim 1.

12. A part of a vehicle comprising:
at least one component part made of amber manufactured accordance with the method of claim 1.
